(19) United States
(12) Patent Application Publication
(10) Pub. No.: US 2006/0218185 A1
(43) Pub. Date: Sep. 28, 2006

(54) Construction document management system

(75) Inventor: Erich Lemke, Cumming, IA (US)

Correspondence Address: BRETT J. TROUT, PC, 516 WALNUT, DES MOINES, IA, 50309, US

(73) Assignee: DATA BUILDER, INC.

(21) Appl. No.: 11/086,706

(22) Filed: Mar. 22, 2005

(51) Int. Cl. G06F 17/00

(52) U.S. Cl. 707/104.1; 707/200

(57) ABSTRACT

A construction document management system, including a database containing a plurality of documents associated with a plurality of file types, and a search system for searching across documents contained on the multiple platforms, utilizing either search criteria associated with the particular documents, text contained within the documents and/or annotations associated with the documents. The system is also provided with an integrated lifecycle management system which deletes the appropriate documents at predetermined dates selected by the user. Preferably, at the construction closeout date, the entire database is provided to the owner along with the software program which allows the owner to search and retrieve any desired documents, and which automatically deletes documents upon their predetermined destruction date.

### BACKGROUND OF THE INVENTION

1. Field of the Invention

This invention relates to the management of construction related documents and, more specifically, to a system for the electronic capture, management, retrieval, output and lifecycle management of construction related documents.

2. Description of the Prior Art

It is generally known in the art to produce, capture, store, retrieve and destroy documents of a similar type. This process can range from all of the operations being of a manual type, as is the case with certain types of blueprints, to all of the operations being of an automated electronic type, as is the case with certain Internet related “cookies” or the like. Construction projects typically encompass a myriad of document types, ranging from hand drawn notes, to executed legal documents, to computer text documents, to photographs and manuals. Typically these documents are collected, ordered and stored in banker's boxes. Such prior art filing system must, to some extent, be arbitrary, making it difficult to obtain a particular document, especially if only a few attributes of the document are known.

Although electronic documents may be stored on a compact disc or other digital media, a searcher must typically have numerous and sometimes obscure software programs just to read, let alone search and retrieve, the large number of document types associated with the typical construction project. Additionally, if it is desirable to annotate one or more documents, prior art annotation procedures are typically clumsy, if they exist at all, and typically do not include a search feature.

Still another drawback associated with the prior art is the difficulty associated with document lifecycle management. In the prior art, document lifecycle management typically involves production of a hard copy sheet listing the desired destruction date of various documents. These dates often comport with document retention legislation and/or a particular company's document retention policy. Ostensibly, on the date slated for destruction of a particular document, someone physically searches for the document, physically removes the document from the location, shreds or otherwise physically destroys the document, and then updates the list to reflect the destruction. Several drawbacks associated with this process include the inability to determine if all copies of the document have been destroyed, and the potential that someone will either forget or otherwise not destroy the documents on the predetermined date. Although document lifecycle management systems are known in the art, none of the known systems provides an enterprise solution capable of providing a central command location for automatically destroying all of the various types of documents associated with the typical construction closeout process.

It would, therefore, be desirable to provide a centralized system for capturing any desired type of document into a centralized database. It would be desirable for such a capture system to include the ability to capture not only digital documents, but hard copy documents, photographs and oversized drawings and the like, such as standardized blueprints and material specification sheets: It would also be desirable to provide the system with sufficient software capability to display every type of document, spreadsheet, photograph, blueprint or other document captured in the system. It would be desirable to provide the system with an electronic method for capturing, sorting and filing the documents in either predetermined or user defined folders and subfolders. It would further be desirable to provide a comprehensive database for the storage of all of the documents which also provided for annotation of the files to include information relating to the contents of the document, the file type and the original source format of the document. It would be desirable to provide the system with a user defined or automatic document lifecycle management system which provided for the automatic, electronic destruction of documents to comport with legislative and/or corporate retention mandates.

The difficulties encountered in the prior art discussed hereinabove are substantially eliminated by the present invention.

### SUMMARY OF THE INVENTION

In an advantage provided by this invention, a method is provided for efficiently capturing a plurality of various types of documents used in association with a construction project.

Advantageously, this invention provides a method for managing a plurality of documents associated with a construction project.

Advantageously, this invention provides a method for the efficient search and retrieval of various documents associated with a construction project.

Advantageously, this invention provides a method for efficient display of various documents associated with a construction project.

Advantageously, this invention provides a method for automated destruction of various documents associated with a construction project in accordance with legislative and corporate document retention mandates.

Advantageously, this invention provides a method for capturing a single document into a multiplatform database for use in association with a construction project.

Advantageously, this invention provides a method for managing a single document into a multiplatform database for use in association with a construction project.

Advantageously, this invention provides a method for searching and retrieving a single document from a multiplatform database for use in association with a construction project.

Advantageously, this invention provides a method for displaying a single document of a multiplatform database for use in association with a construction project.

Advantageously, this invention provides a method for destroying a single document in a multiplatform database for use in association with a construction project in accordance with legislative and corporate document retention mandates.

Advantageously, this invention provides a method for allowing multi-user access to documents utilized in association with a multiplatform database used in association with a construction project.

Advantageously, this invention provides a method for storing construction documents associated with various platforms in a database associated with a multiplatform reader search and retrieval system.

Advantageously, this invention provides a method for allowing annotation of various documents in various formats associated with a construction project.

Advantageously, in a preferred example of this invention, a method for managing documents associated with a construction project is provided, comprising capturing various documents associated with a construction project, and associating them with a database. Such documents may include blueprints, legal contracts, construction schedules, material specifications, correspondence, change orders and closeout documents. Preferably, the documents are captured in electronic format and stored electronically on the database. Preferably, key words associated with each one of the documents are searchable to retrieve desired documents. Although the documents may be stored in numerous formats, including word processing formats, database spreadsheet and photographic formats, they are all preferably searchable, retrievable and viewable, utilizing the single cross-platform system of the present invention. Additionally, the system provides for user annotation of the various documents and lifecycle management to associate a predetermined length of time with a particular file. After the predetermined time, the system automatically deletes all copies of the file contained within the database to comport with corporate and legislative document retention requirements.

### BRIEF DESCRIPTION OF THE DRAWINGS

The invention will now be described with reference to the drawings and certain preferred embodiments which are intended to illustrate and not limit the invention, and in which:

FIG. 1 illustrates a high level architectural drawing illustrating the primary components of a system that operates in accordance with the present invention;

FIG. 2 illustrates a schematic illustrating the interaction of the components of the system;

FIG. 3 illustrates a flowchart of an exemplary process for capturing documents in an electronic format;

FIGS. 4A-4B illustrate a flowchart of an exemplary process for filing electronically captured documents into a database of the present invention;

FIG. 5 illustrates exemplary database entries of the present invention;

FIG. 6 illustrates a diagram of the various document types associated with the database of the present invention;

FIG. 7 illustrates a flowchart of an exemplary process of the present invention associated with document lifecycle management in which documents stored electronically in various formats are associated with a predetermined length of time and then automatically deleted after the expiration of that time period;

FIG. 8 illustrates a flow chart of an exemplary overview of the process of the present invention.

### DETAILED DESCRIPTION OF THE PREFERRED EMBODIMENT

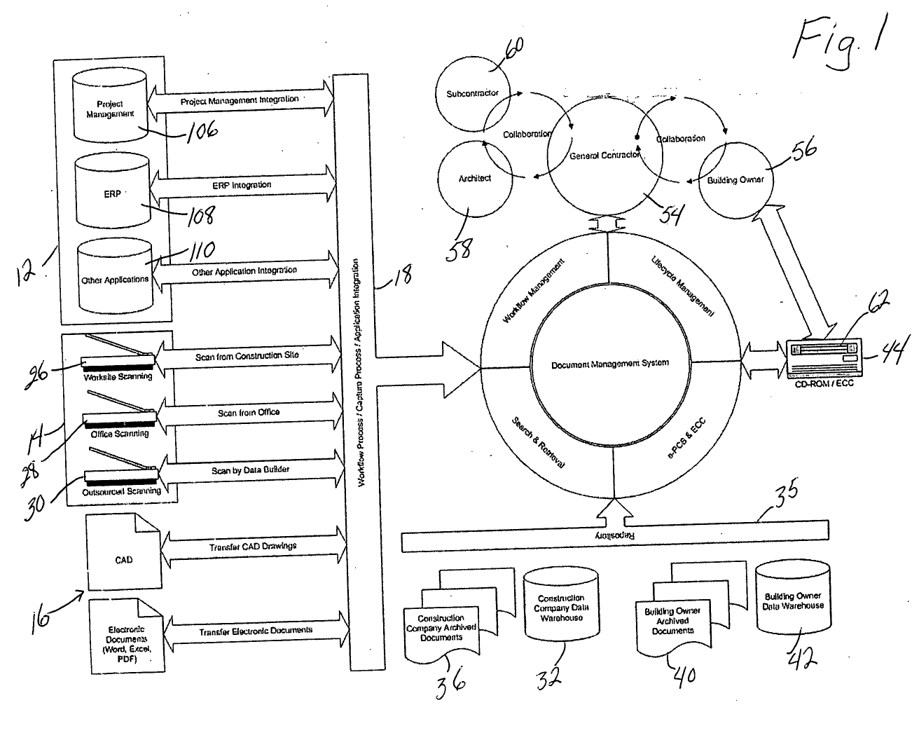

The present invention provides a method and system for managing documents associated with construction projects. The capture, filing, retrieval and lifecycle systems of the present invention streamline the construction document management process, eliminating the need for prior art bankers boxes filled with obsolete and/or unsearchable documentation. In one embodiment of the present invention, the user captures construction documents and converts them into a compatible electronic format. The user then files and stores the electronic revisions of the documents on a database. The database provides a search mechanism for retrieval of the documents. Search criteria may be based upon creation date, destruction date, file type, document type, document original format, test within the document and/or annotation associated with the document. The system also provides for lifecycle management of the document, automatically deleting all copies of the document from the database upon a predetermined destruction date, which may be associated with each document. The management system of the present invention is illustrated generally as the architectural diagram (10) of FIG. 1.

As shown in FIG. 1, the system incorporates a plurality of software applications (12), capture devices (14) and documents (16). The system (10) is also provided with software (18) which integrates the various applications (12), facilitates the capture of documents (16) utilizing the capture devices (14), and coordinates workflow processes. Although the software (18) may be written in any desired programming language, it is preferably written to accomplish all of the processes outlined herein. The software (18) may use any desired software architecture known in the art, and in the preferred embodiment utilizes the software program (name of program), distributed by (distributor) of (address of distributor) to integrate the various software applications (12) and (name of program) distributed by (distributor) of (address of distributor) for the lifecycle management portion of the software (18) described below. Although the software (18) is written to execute the procedures described herein, it will be obvious to one of ordinary skill in the art that the software (18) may be readily adapted to execute more or fewer procedures than those described herein.

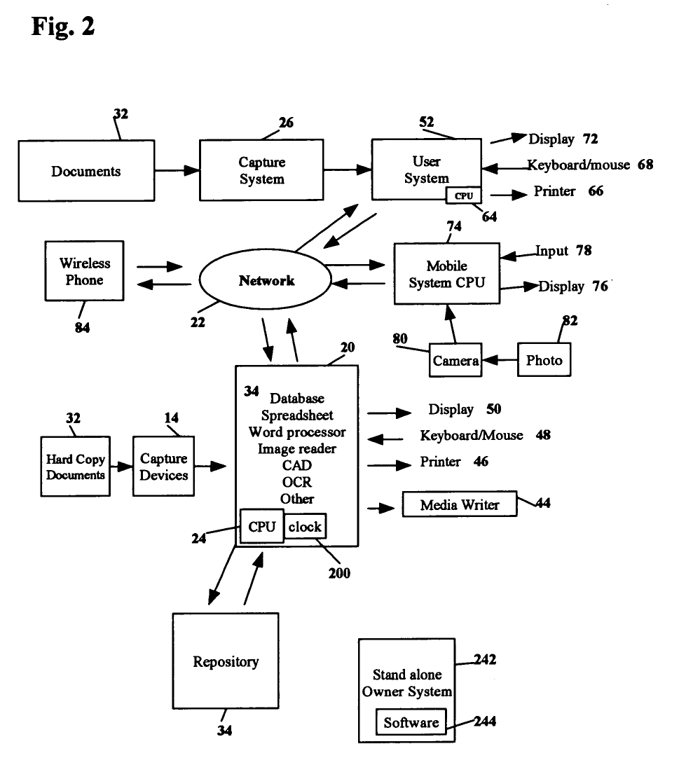

As shown in FIG. 2, the software (18) is preferably provided on a server system (20) coupled to a network (22), which may be an intranet or, in the preferred embodiment, the Internet. Preferably, as shown in FIG. 2, the server system (20) includes a central processing unit (24) which, in the present invention, is preferably a Pentium 4 class processor. The server system (20) is preferably hardwired to the Internet, but may be connected wirelessly or by any desired method known in the art.

As shown in FIG. 2, the capture devices (14) are coupled to the server system (20). As shown in FIG. 1, the capture devices may include such devices as a worksite scanner (26), an office scanner (28) and an outsourced scanner (30). The scanners (26), (28) and (30) may, of course, be of any type known in the art, but are preferably of a standard type known for converting a “hard copy” of a document to electronic format. In the preferred embodiment, the scanners (26), (28) and (30) are preferably provided with optical character recognition software and software sufficient to convert documents to an electronic file format compatible with the software (18). While the scanners (26), (28) and (30) may be of any size known in the art, at least one of these scanners (26), (26) or (30) is preferably oversized to accommodate blueprints and other construction related documentation which may be thirty centimeters or more in length, and which may even be fifty or more centimeters in length.

As shown in FIG. 2, hard copy documents (32) are processed through the capture devices (14) to provide format compatible electronic documents to a database (34) associated with the software (18). The database (34) may be constructed utilizing any database software known in the art, but in the preferred embodiment uses the software program (name of program) distributed by (distributor) of (distributor's address).

As shown in FIG. 2, the database (34) is also associated with an electronic document repository (35). The repository (35) contains documents and materials which may be used across several construction projects such as contact information, product specifications and the like. As shown in FIG. 1, the repository (35) includes contractor archive documents (36), contractor electronic data storage (38), owner archive documents (40), and owner electronic data storage (42). The repository (35) can consist of any desired materials, but in the preferred embodiment utilizes documents previously stored by the contractor, architect or building owner, or documents which would be utilized by any of these entities for additional projects. As shown in FIGS. 1 and 2, the database (34) is also associated with a media writer (44) which may be a CD ROM writer, a DVD writer, or any similar portable media writer. As the database (34) is stored on the server system (20) the media writer (44) is preferably coupled to the server system (20), as are a printer (46), a keyboard mouse (48), and a display (50).

As shown in FIG. 2, coupled to the server system (20) via the network (22) is a user system (52). Preferably, a plurality of user systems (52) are associated with the network (22) to provide remote access for the general contractor (54) and building owner (56). If desired, limited or full remote access may also be supplied to the architect (58) and subcontractor (60). As shown in FIG. 1, however, in the preferred embodiment the general contractor (54) alone has direct access to the server system (20). The building owner (56), architect (58) and subcontractor (60) are provided indirect access to the server system (20) through the general contractor (54). Although the building owner (56) may be provided with access to media (62), this is preferably “read only” access. The advantage provided by allowing only the general contractor (54) direct access to the server system (20) is in maintaining the integrity of the information contained within the server system (20) and increasing security associated with a reduction in the number of authorized users. Limiting the users in this manner also facilitates troubleshooting if the server system (20) becomes infected with a virus or experiences a security breach.

As shown in FIG. 2, the user system (52) is preferably a central processing unit (64) of a Pentium 4 class or greater. The user system (52) may be hard wired or wirelessly connected to the network (22). As with the server system (20), the user system (52) is provided with a printer (66), a keyboard and mouse assembly (68), and a display (70). As with the peripherals associated with the server system (20), the peripherals associated with the user system (52) may be of any type known in the art. Although not required, the user system (52) is preferably coupled to a scanner (26) to capture hard copy documents (32) available to the user.

As shown in FIG. 2, also coupled to the network (22) is a mobile system (74), such as a personal digital assistant or the like. Although the mobile system (74) may be a full power, full function system similar to that associated with the user system (52), the mobile system (74) may alternatively be a read only and/or limited input system. The mobile system (74) is preferably provided with a display (76) and an input device (78), such as a stylus, keyboard or the like. The mobile system (74) may also be coupled to a digital camera (80) or scanner to allow uploading of hard copy documents (32) or photographs (82) to the server system (20). Also shown in FIG. 2, a wireless telephone (84) such as those known in the art may be coupled to the network to upload and download information from the server system (20).

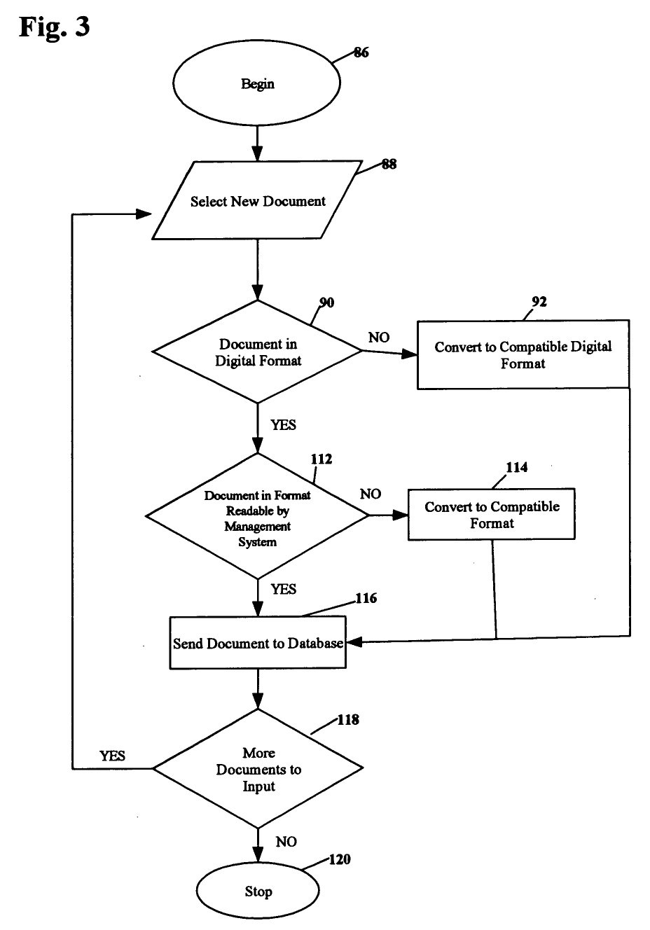

When it is desired to begin utilization of the management system (10) in accordance with the present invention, the user begins at step (86) shown in FIG. 3. This step begins the process of document capture which may be initiated by the general contractor (54), building owner (56), architect (58), subcontractor (60), or any other desired entity. As shown in step (88), after the document has been selected, it is determined whether the document is in a digital format. If the document is not in a digital format, such as a hard copy document or a building which must be photographed, in step (92) the document is converted into a digital format, either by scanning, digital photography, or any method known in the art. Preferably, the conversion translates the document into a digital format which is compatible with the software (18) and at least one program associated with the server system (20). As shown in FIG. 2, the server system (20) is preferably associated not only with the database (34), but with spreadsheet software (94), word processor software (96), image manipulation software (98), computer aided drawing software (100), optical character recognition software (102), and any other desirable software (104). Although these programs are well known in the art, no system fluidly integrates documents associated with all of these various formats.

Accordingly, the software (18) must be designed to fluidly integrate these programs so that all documents filed in the database (34) associate with at least one program capable of displaying the document. The database (34) is also associated with project management software (106), enterprise resource planning software (108), and any other software applications (110) which the general contractor (54), building owner (56) or any other entity may currently be running, or may have a desire to run, in association with the management system (10) of the present invention. Accordingly, software (18) must not only integrate the display programs associated with the documentation, but must also integrate the project management software (106), enterprise resource planning software (108), and any other software applications (110), to allow these applications (106), (108) and (110) to access the database (34) and retrieve any desired documents therefrom.

As shown in step (90) of FIG. 3, if the document is already in a digital format, in step (112) it must be determined whether the document is in a format displayable by one of the software packages associated with the server system (20). If the document is not in such a compatible format, then in step (114) the document is converted into a format readable by one of the software applications associated with the server system (20). Once the document has been converted into a compatible digital format, either in steps (92) or (114), the document is sent to the database (34) in step (116). As shown in step (118), if there are no more documents, then the process is stopped in step (120). However, if there are additional documents, the process returns to step (88) and repeats itself Although users may input documents in any desired manner, preferably the documents are input either utilizing the “print” utility associated with the user system (52), selecting an “upload” option from the graphical user interface associated with the user system (52), such as those known in the prior art, or entering the server system (20) and utilizing the software (18) to select an upload option for bringing the document onto the server system (20).

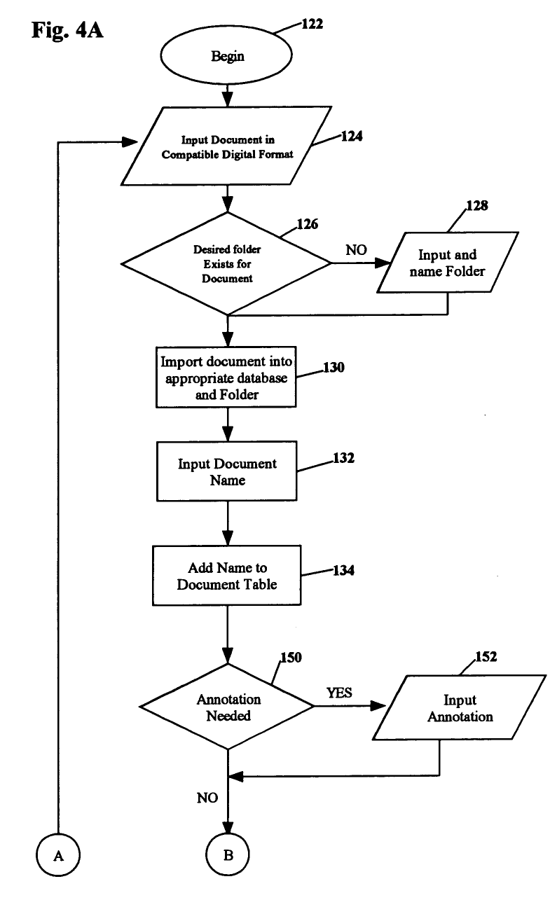

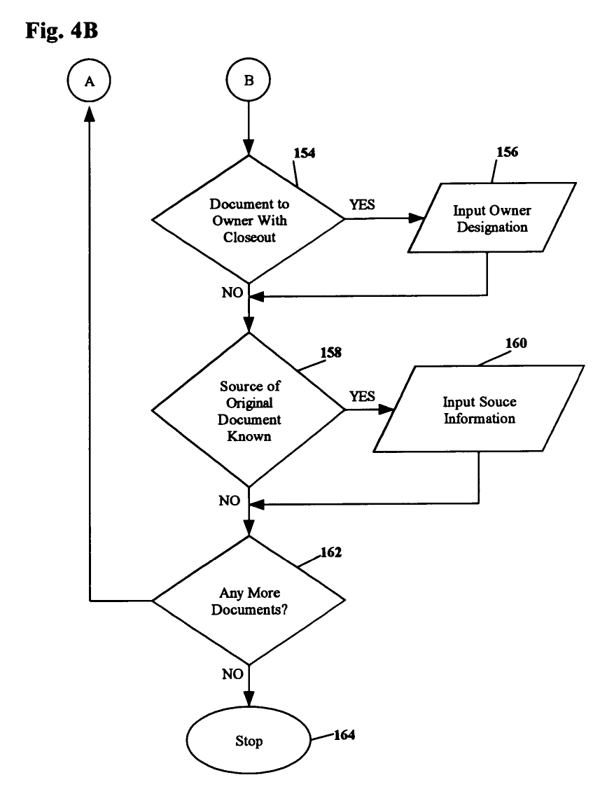

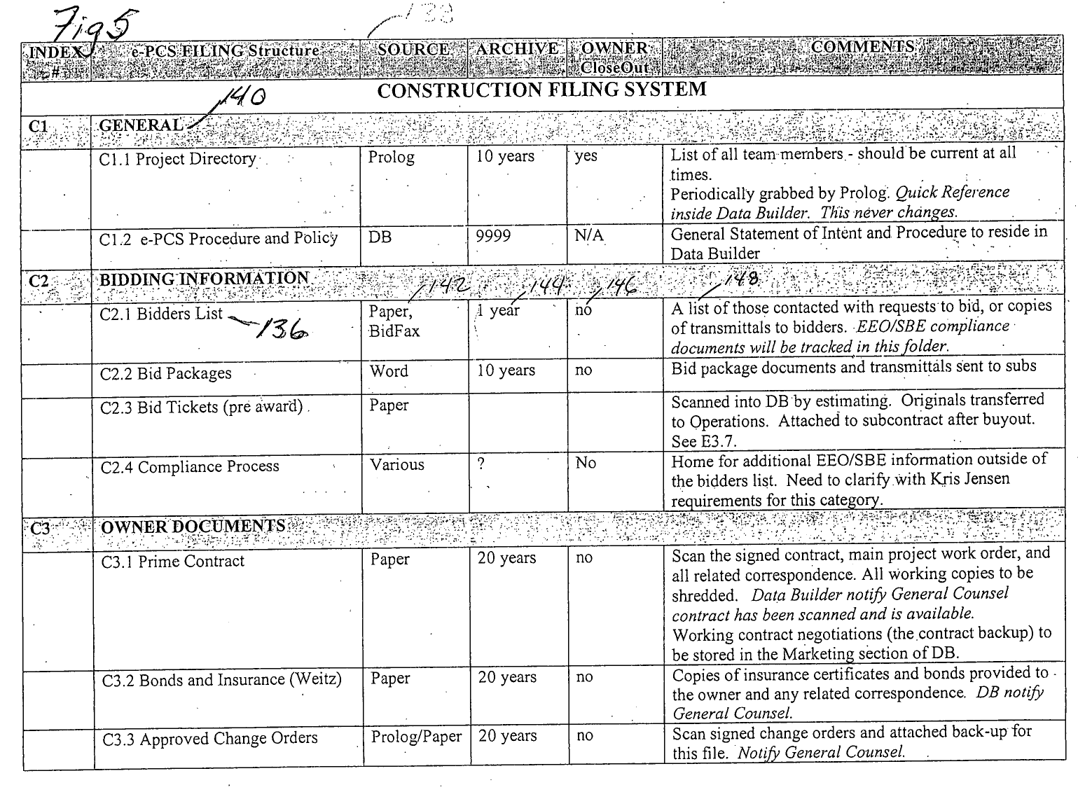

Once the document has been captured in a compatible digital format, the process begins in step (122) of FIG. 4 to store the document in the database (34). From the process described in FIG. 3 above, the result is the input of a document in a compatible digital format as shown in step (124). Once the document has been input in a compatible digital format, in step (126) it is determined whether an appropriate folder currently exists within the database (34) under which the document is to be filed. If no such folder exists, as shown in step (128), a user inputs a folder and names the folder, utilizing the keyboard and mouse (48) of the server system (20), or any suitable input device associated either directly or indirectly with the server system (20). Once the appropriate folder has been created and named, in step (130) the document is imported into the appropriate database folder. In step (132) a user uses the keyboard/mouse (48) or similar input device to input the name of the document into the database (34). Once the document name has been added, as shown in step (134), the name of the document (136) is added to the document table shown generally as (138) in FIG. 5. As shown, the document table (138) also lists the folder name (140), original source (142) of the document, the archive term (144), a designation (146) as to whether the document is to be provided to the owner upon closeout, and an annotation (148).

Once the document name (136) has been added to the document table (138), in step (150) it is determined whether an annotation (148) is to be added to the table (138). In step (152), a user utilizes a keyboard and mouse (48) to input an annotation (148). If no annotation (148) is to be added, in step (154) it is determined whether the document is to be provided to the owner upon closeout. If the document is to be provided to the owner upon closeout, in step (156) a user utilizes the keyboard and mouse (48) to add the owner designation (146) to the document table (138). If no owner designation (146) is to be added, in step (158) the source of the original document is determined. If the source of the original document can be determined, the source (142) is added to the document table (138) as shown in FIG. 5. If the source is not known, the field in the document table (138) is left blank, and in step (162) it is determined whether any more documents are to be added to the document table (138). If any more documents are to be added, the process returns to step (124) where the initial document is input. If no documents are to be added, the process stops in step (164).

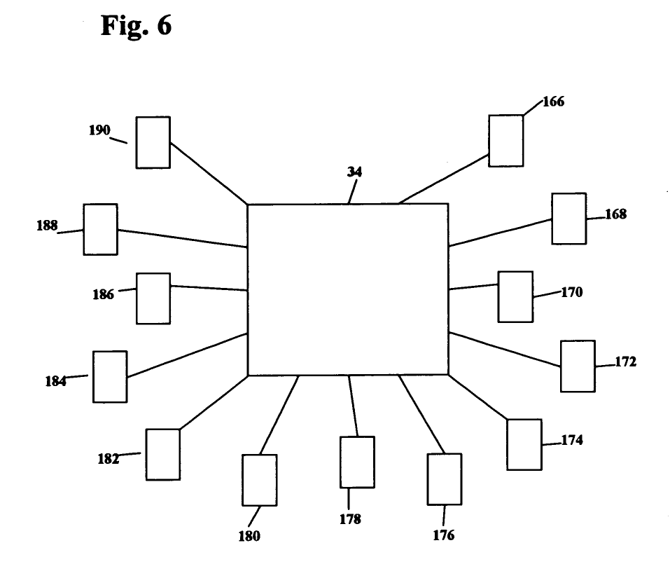

Although documents may be of any desired type, as shown in FIG. 6, in the preferred embodiment, the documents may include:

Bid documents (166)
bidder list
bid packages
bid tickets
bid compliance documentation

Legal contracts (168)
prime contract
bonds and insurance
approved change orders
pending or potential change orders
rejected change log items
owner communications
original contract drawings and specifications
pay applications and lien waivers

Subcontractor and vendor contracts (170)
purchase order/subcontracts
subcontractor bonds and insurance change orders
pending/potential change orders
rejected change log items
communications,
pay applications
lien waivers

Contract documents (172)
drawings and specifications lists
addendums
ASICCD
PR
RFI

Costs (174)
code adjustments
job status inquiries
additional cost reports

Schedule (176)
construction schedule
two-week look ahead schedule

Safety (178)
subcontractor specific safety plans
safety white papers
safety correspondence
safety training
safety audits

Project management (180)
total project plan
safety plan
daily reports
test results
inspections
owner observations
government inspections
field observations
permits
photographs
field observation reports
progress reports
submittal log
miscellaneous articles and correspondence

Meetings (182)
meeting minutes

Communications (184)
email hard copy
letters in word processing format
facsimiles
telephone messages

Project closeout (186)
substantial and final completion certificates
certificate of occupancy
punch lists
guarantees
post mortem report
contractor as built drawings
subcontractor as built drawings
operations maintenance
extra stock list
schedule certification and testing
owner training
other requirements
warranty

Preconstruction (188)
estimates/closer documents
value analysis
final estimates

Corporate (190)
accident and incident reports

Although all of the foregoing documents need not be added to the database (34), and while additional documents may be added, the foregoing is representative of the types of documents utilized in association with a construction project and the method and apparatus of the present invention.

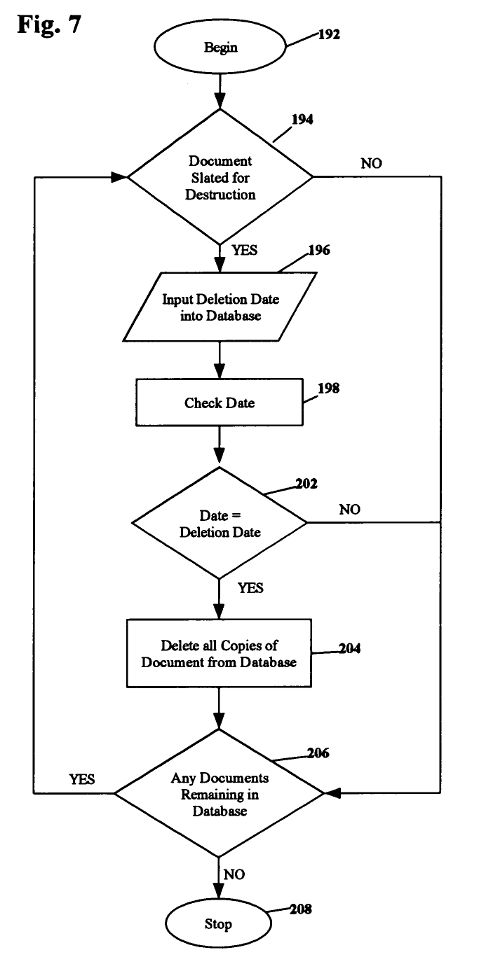

As shown in FIG. 7, once a document has been added to the database (34), the lifecycle management process begins as shown in step (192) of FIG. 7. As shown in step (194), the initial determination must be made as to whether a document is slated for destruction. If a document is slated for destruction, in step (196) a user utilizes the keyboard and mouse (48) to input the archive (144) into the document table (138) as shown in FIG. 5. In FIG. 7, in step (198), the server system checks an internal clock (200). As shown in step (202), if the current date from the internal clock (200) does not match the deletion date associated with the archive (144), then the process returns to step (194) and repeats. However, if the date from the internal clock (200) does equal the deletion date associated with the archive (144), in step (204) all copies of the document are deleted from the database (34). Once all copies of the document have been deleted from the database (34), the process moves to step (206) to step (194) to see if there are any additional documents slated for destruction. The process repeats until no documents remain in the database (34), causing the process to stop in step (208).

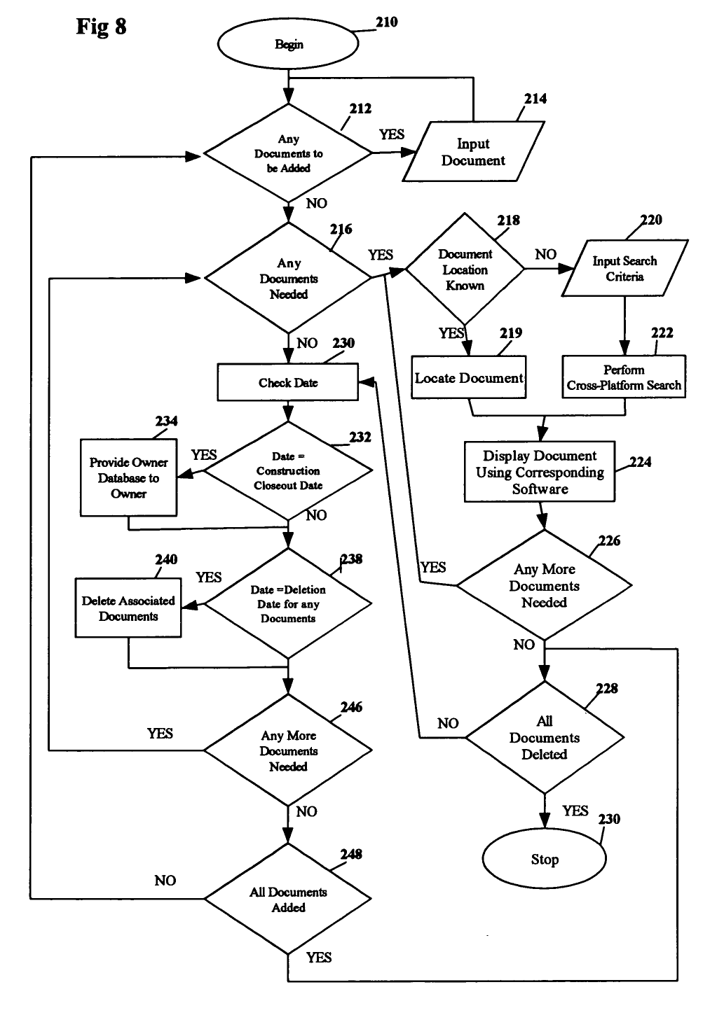

As shown in FIG. 8, an overview of the entire process begins in step (210). As a first step in the process (212), it is determined whether any documents are to be added to the database (34). If additional documents are to be added in step (214), the additional documents are added in accordance with the description provided above in association with FIG. 3. Once all of the documents have been added, the process moves to step (216), which determines whether any documents are needed by the user. If any documents are needed, the process moves to step (218) to determine if the location of the particular document needed is known. If the location of the document is known, the process moves to step (219), where the document is located by the user and then to step (224) where the document is displayed as described above. If the location of the document is not known, the process moves to step (220), in which the user utilizes the keyboard and mouse (48) to input search criteria into the server system to retrieve the documents.

A text search is preferably performed across all of the platforms to search not only the document names but also the comments annotated to the documents, and text contained with the documents. The text within the documents may either be searched in an ASCI format associated with the native file type or the document, if not of a format searchable using a standard text search system, is preferably processed through an optical character recognition system such as those known in the art to provide searchable terms to utilize in association with a cross platform search of step (222), which searches all of the documents regardless of the program with which the document is associated. Preferably, the cross platform search searches all of the word processing, spreadsheet, graphic and other program based documents associated with the database (34).

Preferably the search can be further or alternatively narrowed by storage date, destruction date, creation date, author, native file type, folder and/or the party providing the document, inputting the document into the system, or receiving the document on closeout. For example, if it is desirable to retrieve a particular bid document created in June of the same year, the search criteria can be identified as the folder associated with big documents and the creation date. In response to the search, as shown in step (224), the server system (34) displays the retrieved document on the display (52) or the display (76), depending on whether the document was requested from the server system (34), user system (52), or mobile system (74). Preferably, the software (18) automatically associates the retrieved document with the appropriate software utilized to display the requested document. For instance, if a word processing document is searched and retrieved, the software (18) executes the word processing software package to display the retrieved document in the appropriate format.

Once the document has been displayed, the process moves to step (226), which determines whether any additional documents are needed. If additional documents are needed, the process returns to step (218) and the process is repeated. If no additional documents are needed, the process moves to step (228) to determine if all of the documents in the database (34) have been deleted. If all of the documents have not been deleted, or if after step (216) no additional documents are needed, the process moves to step (230). Step (232) then determines whether the date is the same as the construction closeout date stored within the server system (20). The construction closeout date is a predetermined date previously input into the server system (20) by a user. This date may or may not be listed in the document table (138) and may require administrator or password rights to amend. The construction closeout date is preferably the date on which the documents identified as being transferred to the owner are provided onto digital media and provided to the owner. Alternatively, the documents may be moved to an alternative database accessible to the owner, either on a separate hard drive or via a network, such as the Internet.

As shown in step (232), if the date does equal the construction closeout date, in step (234) the media writer (44) is utilized to produce a digital media copy of the files identified in the document table (138) as to be transferred to the owner. Preferably, the resulting media is of a read only variety, to prevent unintentional deletion of any of the files. Alternatively, the media (236) may be of a read write variety and associated with a software program which runs the process of FIG. 7 against the data contained within the electronic media (234) to delete documents on their appropriate destruction date. As another alternative, the documents may be provided on a hard drive which may be accessed either directly or via a network to run the process of FIG. 7 to delete the documents on the appropriate date.

As a further alternative, the electronic media (236) may be provided to the owner who thereafter downloads the information contained on the electronic media onto a read/write media, such as a read/write compact disc or DVD or hard drive, and utilizes the stored information in association with software which runs the program associated with FIG. 7 to delete the documents at the appropriate times. In this embodiment, the electronic media is preferably destroyed, so that upon deletion of the documents on the appropriate deletion dates, no additional copies of the documents remain.

As shown in FIG. 7, if the date is not the construction closeout date, or if the database (34) has already been provided to the owner, the process moves to step (238) to determine whether the date is the deletion date of any documents contained within the database (34). If the date is the deletion date of any documents, in step (240) all of the associated documents are deleted. Preferably, whether the documents are stored in the server system (20) or on a stand-alone system (242) operated by the owner, both the owner system (242) and server system (20) are used in association with software (18) and (244), which automatically deletes all copies of the document slated for deletion on the same day, so that no copies of the document remain. If the date does not equal the deletion date for any documents, or if all of the documents associated with the deletion date have been deleted, the process moves to step (246) to determine if any more documents are needed. If more documents are needed, the process returns to step (216) and repeats. If no additional documents are needed, the process moves to step (248) to determine if all of the documents to be associated with the database (34) have been added to the database (34). If additional documents are to be added, the process returns to step (212) and repeats. If, however, all of the documents have been added to the system, the process moves to step (228). As shown in step (228), as explained above, if all of the documents have not been deleted from the database (34), the process returns to step (230) and repeats. If all of the documents have been deleted from the database (34), the process moves to step (230) where it terminates. At this stage, if all of the documents have been deleted from the database (34), the folder names (140) and document table (138) can be erased and the process repeated for another construction project.

The foregoing description and drawings merely explain and illustrate the invention, and the invention is not limited thereto, except insofar as the claims are so limited as those skilled in the art who have the disclosure before them will be able to make modifications and variations therein without departing from the scope of the invention. For example, it is anticipated that the systems may either be hard-wired or connected wirelessly, and may include any number, types or configurations of systems. It is further anticipated that the server system (20) and software (18) may be utilized with any desired number of projects, each of which may be associated with a separate database (34) and document table (138). It is also anticipated that the management system of the present invention may be utilized in association with any types of projects utilizing a plurality of document types which may need to be accessible from a variety of locations, and which may need to be deleted at predetermined periods of time. It is additionally anticipated that if multiple projects are utilized in association with the server system (20) that the server system (20) may be utilized in association with a plurality of databases, some of which such as the database (34) may be utilized exclusively in association with a single project, databases such as the repository (35) which may be used across all databases, and additional databases which may be utilized by a subset of projects or only projects associated with a particular type of project, such as construction projects.

What is claimed is:

1. A method for managing documents associated with a construction project, said method comprising:
(a) capturing a blueprint in electronic form;
(b) capturing a legal contract in electronic format;
(c) capturing a construction schedule in electronic format;
(d) capturing material specifications in electronic format;
(e) capturing correspondence in electronic format;
(f) capturing change orders in electronic format;
(g) creating a database of files comprising:
(i) said blueprint in electronic format;
(ii) said legal contract in electronic format;
(iii) said construction schedule in electronic format;
(iv) said material specifications in electronic format;
(v) said correspondence in electronic format; and
(vi) said change orders in electronic format.
(h) associating a first plurality of words with said blueprint;
(i) associating a second plurality of words with said legal contract;
(j) associating a third plurality of words with said material specifications;
(k) associating a fourth plurality of words with said correspondence;
(l) displaying said blueprint in response to a search of at least one of said first plurality of words;
(m) displaying said legal contract in response to a search of at least one of said second plurality of words;
(n) displaying said material specifications in response to a search of at least one of said third plurality of words;
(o) displaying said correspondence in response to a search of at least one of said fourth plurality of words;
(p) associating a predetermined length of time with a delete file selected from said database of files; and
(q) deleting all copies of said delete file from said database of files after said predetermined length of time.

2. The method for managing documents associated with a construction project of claim 1, further comprising using a graphical user interface to associate a supplemental predetermined length of time with said legal documents and deleting said legal contract after said predetermined length of time.

3. The method for managing documents associated with a construction project of claim 1, further comprising using a graphical user interface to define a folder and associate a plurality of files with said folder wherein at least one of said files is a file selected from the group consisting of said blueprint, said legal document, said material specifications, and said correspondence.

4. The method for managing documents associated with a construction project of claim 1, further comprising associating a user defined comment with a file selected from the group consisting of said blueprint, said legal document, said material specifications, and said correspondence.

5. The method for managing documents associated with a construction project of claim 1, further comprising:
(a) providing a graphical user interface; and
(b) associating said predetermined length of time with said delete file using said graphical user in interface.

6. The method for managing documents associated with a construction project of claim 5, further comprising using said graphical user interface to define a folder and associate a plurality of files with said folder wherein at least one of said files is a file selected from the group consisting of said blueprint, said legal document, said material specifications, and said correspondence.

7. The method for managing documents associated with a construction project of claim 6, further comprising using said graphical user interface to associate a user-defined comment with a file.

8. The method for managing documents associated with a construction project of claim 7, further comprising using said graphical user interface to display a file type origin associated with a file selected from the group consisting of said blueprint, said legal document, said material specifications, and said correspondence.

9. The method for managing documents associated with a construction project of claim 5, further comprising using said graphical user interface to associate a user defined comment with a file selected from the group consisting of said blueprint, said legal document, said material specifications, and said correspondence.

10. The method for managing documents associated with a construction project of claim 5, further comprising using said graphical user interface to display a file type origin associated with a file selected from the group consisting of said blueprint, said legal document, said material specifications, and said correspondence.

11. The method for managing documents associated with a construction project of claim 5, further comprising using said graphical user interface to select a file selected from the group consisting of said blueprint, said legal document, said material specifications, and said correspondence and displaying said file in response to said selection.

12. The method for managing documents associated with a construction project of claim 5, further comprising using said graphical user interface to associate a subset of files selected from the group consisting of said blueprint, said legal document, said material specifications, and said correspondence with an entity.

13. The method for managing documents associated with a construction project of claim 12, further comprising forwarding said subset to said entity.

14. The method for managing documents associated with a construction project of claim 1, further comprising associating a subset of files selected from the group consisting of said blueprint, said legal document, said material specifications, and said correspondence with an entity and forwarding and subset to said entity.

15. A method for managing documents associated with a construction project across a computer network, said method comprising:
(a) creating a database of construction documents comprising:
(i) a blueprint;
(ii) a legal contract;
(iii) a construction schedule.
(b) a first user located at a first location;
(c) a second user located at a second location remote from said first location; and
(d) allowing simultaneous access of a document of said database of construction documents by said first user and said second user.

16. The method for managing documents associated with a construction project across a computer network of claim 15, wherein said first user is a contractor and where said second user is an architect.

17. The method for managing documents associated with a construction project across a computer network of claim 15, wherein said computer network is the Internet.

18. The method for managing documents associated with a construction project across a computer network of claim 15, associating a predetermined length of time with a construction document associated with said database of construction documents and deleting said construction document after said predetermined length of time.

19. A method for managing documents associated with a construction project across a computer network, said method comprising:
(a) creating a database of construction documents comprising:
(i) a blueprint;
(ii) a legal contract;
(iv) a construction schedule.
(b) a change order;
(c) a first user located at a first location;
(d) a second user located at a second location remote from said first location;
(e) allowing simultaneous access of a document of said database of construction documents by said first user and said second user; and
(f) using a graphical user interface to associate a predetermined length of time with said legal contract and deleting said legal contract after said predetermined length of time.

20. The method for managing documents associated with a construction project across a computer network of claim 19, further comprising:
(a) associating a first plurality of words with said blueprint;
(b) associating a first plurality of words with said legal contract;
(c) displaying said blueprint in response to a search of at least one of said first plurality of words; and
(d) displaying said legal contract in response to a search of at least one of said second plurality of words.
